(19) United States
(12) Patent Application Publication
(10) Pub. No.: US 2026/0217363 A1
(43) Pub. Date: Jul. 30, 2026

(54) SYSTEM AND METHOD FOR ELECTRONIC PITCH STABILITY AUGMENTATION

(71) Applicant: Textron Aviation Inc., Wichita, KS (US)

(72) Inventors: Stephen M. Eddy, Benton, KS (US); Steven G. Hagerott, Wichita, KS (US)

(21) Appl. No.: 19/040,506

(22) Filed: Jan. 29, 2025

(51) Int. Cl. B64C 13/50; B64C 13/16; B64C 30/00

(52) U.S. Cl. CPC B64C 13/50; B64C 13/16; B64C 30/00

(57) ABSTRACT

A pilot assist system and method for providing electronic pitch stability for an aircraft. The system includes sensors mountable to the aircraft for sensing one or more conditions experienced by the aircraft in real time. The system also includes at least one servo motor and one or more compensation modules. The at least one servo motor is physically couplable to an aircraft control inceptor and provides reactive forces that work against the pilot or assists the pilot as the pilot manually manipulates the aircraft control inceptor. The one or more compensation modules receive input from the sensors and instruct the at least one servo motor regarding a direction and an amount of the reactive forces that the at least one servo motor provides to the aircraft control inceptor based upon the input from the sensors.

### BACKGROUND OF THE INVENTION

Aircrafts with mechanical flight controls typically require some type of mechanical fixes such as springs, interconnects, surface modifications or centering strips to pass all handling qualities requirements for pitch.

For example, a bob weight is sometimes lever-armed off of a pitch control system and is configured to work against the pilot to increase the control force under a g-load to meet certain regulatory requirements, particularly to assist in situations where the reacting force from the pilot does not increase fast enough or does not increase linearly. Unfortunately, this adds additional weight and additional cost to the manufacturing of the aircraft.

Another mechanical solution for aircraft stability issues is down springs, which increases speed stability. So those add a downforce to the system to bias it in accordance with regulatory requirements. However, the down springs also unfortunately add additional weight to the aircraft.

In addition to adding weight to the aircraft, some of the mechanical fixes currently used to assist in aircraft stability may need to be calibrated or adjusted further based on individual aircraft loads. Specifically, the way the aircraft is loaded (if the center of gravity of the airplane is forward or aft) can influence the control force to the pilot, so a nose-heavy center of gravity may need a lot of control force for the pilot to maneuver the aircraft, as opposed to an aft-heavy center of gravity.

### SUMMARY OF THE INVENTION

Embodiments of the current invention address one or more of the above-mentioned problems and provide a distinct advance in the art of aircraft stability and control. Specifically, some embodiments of the invention include a pilot assist system for providing electronic pitch stability for an aircraft. The system includes sensors mountable to the aircraft for sensing one or more conditions experienced by the aircraft in real time. The system also includes at least one servo motor and one or more compensation modules. The at least one servo motor is physically couplable to an aircraft control system or aircraft control inceptor (e.g., aircraft control lever, aircraft control stick, or the like) and provides reactive forces that work against the pilot or assists the pilot as the pilot manually manipulates the aircraft control inceptor. The one or more compensation modules receive input from the sensors and instruct the at least one servo motor regarding a direction and an amount of the reactive forces that the at least one servo motor provides to the aircraft control inceptor based upon the input from the sensors.

In another embodiment of the invention, a method for providing electronic pitch stability for an aircraft includes a step of receiving, with compensation modules, input from sensors mounted to the aircraft. The sensors sense one or more conditions experienced by the aircraft in real time. The method also includes a step of determining compensation commands via the compensation modules. The compensation commands may be instructions for at least one servo motor based upon the input from the sensors. The method may also include a step of outputting the compensation commands, such as a pitch stability compensation command, to a servo control and dynamics system including the at least one servo motor. The at least one servo motor is physically coupled to an aircraft control inceptor and, based on the compensation commands, provides reactive forces that work against the pilot or assists the pilot as the pilot manually manipulates the aircraft control inceptor.

In yet another embodiment, a method for providing electronic pitch stability for an aircraft includes a step of receiving, with compensation modules, input from sensors mounted to the aircraft. The sensors sense one or more conditions experienced by the aircraft in real time. The method also includes a step of determining compensation commands via the compensation modules. Specifically, the one or more compensation modules may provide compensation commands according to at least one of the following: normal or vertical acceleration augmentation based on aircraft control inceptor force, airspeed augmentation based on aircraft control inceptor force, aircraft center of gravity (CG) normalization based on aircraft control inceptor force, flap extension and retraction force bias, pitch damping, and soft angle of attack (AOA) limit protection. The method may also include a step of summing the compensation commands from the compensation modules into a pitch stability compensation command, with the summing performed in a weighted manner in accordance with flight control requirements. The method may also include a step of outputting the pitch stability compensation commands to a servo control and dynamics system including at least one servo motor. The at least one servo motor is physically coupled to an aircraft control inceptor and is configured to provide reactive forces that work against the pilot or assist the pilot as the pilot manually manipulates the aircraft control inceptor.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a flow chart of an electronic pitch stability augmentation system, depicted components, compensation modules, and outputs thereof in accordance with some embodiments of the invention;

FIG. 2 is a method flow chart depicting a method of providing electronic pitch stability augmentation for an aircraft in accordance with some embodiments of the invention;

FIG. 3 is a chart depicting an example function for one of the compensation modules of FIG. 1 in accordance with some embodiments of the invention;

FIG. 4 is a chart depicting other example functions for one of the compensation modules of FIG. 1 in accordance with some embodiments of the invention;

FIG. 5 is a chart depicting still other example functions for one of the compensation modules of FIG. 1 in accordance with some embodiments of the invention; and

FIG. 6 is a chart depicting additional or alternative example functions for one of the compensation modules of FIG. 1 in accordance with some embodiments of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

When flying an aircraft, the flight control surface aerodynamics may not increase the feedback force applied to an aircraft control inceptor fast enough or in a sufficiently linear manner and may need assistance to increase the control force under a g-load to meet certain regulatory requirements. As described above, prior art methods of accommodating for such issues include mechanical fixes so that the aircraft passes all handling quality requirements, particularly in regards to aircraft pitch. However, those mechanical fixes can add undesired weight to the aircraft, can be expensive to implement, and time-consuming to adjust.

Thus, the present invention overcomes the deficiencies of mechanical fixes by using electronic pitch stability compensation modules instead. Specifically, the present invention uses aircraft sensor signals and applies them to a function and schedule (e.g., the compensation modules) that in turn provide either torque command to a smart servo or position and/or rate commands to fly-by-wire (FBW) surfaces. This can include any combination of the following functions: stick force vs normal or vertical acceleration augmentation, stick force vs airspeed augmentation, stick force vs aircraft center of gravity (CG) normalization, flap extension/retraction force bias, pitch damping, and soft angle of attack (AOA) limit protection, as described in detail below. Inner loops are applied to the servo or surface commands (e.g., via a servo control and dynamics systems) and outer loops are closed via the aircraft state (e.g., aircraft plant) back through the aircraft sensors. In aerospace technology, the inner loop stabilizes the aircraft's dynamics, such as angular velocities and Euler angles. The inner loop controls the aircraft's flight surfaces, such as the ailerons, elevators, and rudder, using sensors and actuators such as the servo described herein. The outer loop controls the aircraft's attitude and speed. The outer loop uses sensors to measure air data, inertial reference, and flight control computers, and sends feedback signals to adjust the aircraft's attitude and speed. The outer loop can also provide additional motion controls, such as speed, altitude, and heading hold.

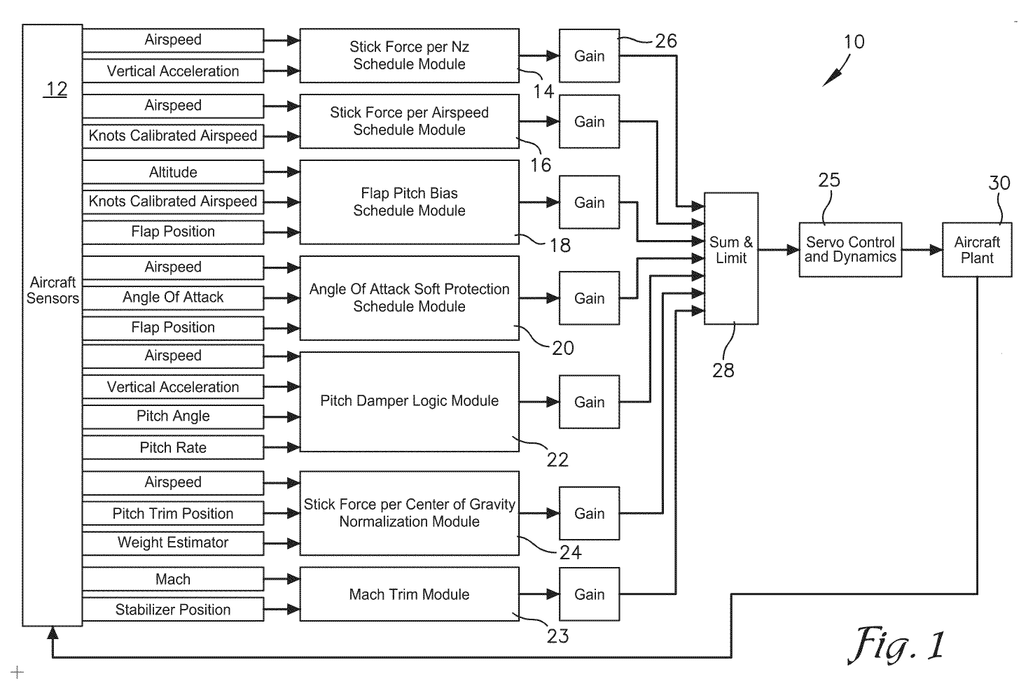

Specifically, as depicted in FIG. 1, an electronic pitch stability augmentation system 10, in accordance with some embodiments of the present invention, includes aircraft sensors 12, compensation modules 14-24, and a servo control and dynamics system 25. Additionally, the system 10 may include various gain circuitry 26 to receive output from the compensation modules 14-24 to boost the signal as needed for additional processing and/or increase or decrease the command authority of the values output by the compensation modules 14-24. The system 10 may also include a signal summing and limiting module 28 executed via hardware circuitry, software, or some combination thereof. The signal summing and limiting module 28 may receive the input from the compensation modules 14-24 and/or the gain circuitry 26 and calculate a desired output to send to the servo control and dynamic system 25. The servo control and dynamics system 25 may include one or more components of the aircraft’s autopilot system, for example. Furthermore, the servo control and dynamics system 25 may control various elements of the aircraft plant 30 (e.g., a stick, such as a lever by which a pilot controls the ailerons and elevator of an aircraft). The response of the aircraft plant 30 can in turn impact the inertial and air data subsequently sensed by the aircraft sensors 12, creating a feedback loop for continual adjustments via the compensation modules 14-24 as needed.

The aircraft sensors 12, as defined herein, can include a number of aircraft sensors and systems, such as an air data system and/or an inertial data system of the aircraft. The aircraft sensors can include sensors that determine one or more of the following: altitude, AOA, flap position, KCAS, NZ, phi, theta, pitch rate, pitch trim position, Qbar, Mach number, roll rate, servo position, side slip estimator data, theta, weight estimator data, or yaw rate. For example, the altitude may refer to barometric altitude as measured by an air data system of the aircraft. The AOA is referred to herein as an “angle of attack” and may be measured by AOA vanes or sensors known in the art. The flap position may be measured by system position sensors on the aircraft. The KCAS is referred to herein as “knots calibrated airspeed” and may be measured by the air data system of the aircraft. Furthermore, NZ is referred to herein as vertical acceleration and may be measured by an inertial data system of the aircraft. Theta is referred to herein as pitch angle. Phi is referred to herein as bank or roll angle. Phi, pitch rate, roll rate, and yaw rate may also be measured by the inertial data system of the aircraft. The pitch trim position is the position of the elevator trim tabs and/or the horizontal stabilizer. Qbar refers to an airspeed measurement (e.g., dynamic pressure as measured by the air data system). Additionally or alternatively, airspeed can be measured as Mach number. The servo position is the position of the output of the control servo. The side slip estimator data may be the calculated aircraft side slip angle based on inertial and air data. Theta is referred to herein as aircraft pitch angle and may be measured by the inertial data system of the aircraft. The weight estimator data may be referred to herein as calculated aircraft weight based on AOA, air, and inertial data.

As depicted in FIG. 1, the compensation modules 14-24 may be executed via hardware, software, or a combination of hardware and software and may include a stick force per NZ schedule module 14, a stick force per airspeed schedule module 16, a flap pitch bias schedule module 18, an AOA soft protection schedule module 20, a pitch damper logic module 22, a stick force per center of gravity (CG) normalization module 24, and a Mach trim module 23. The compensation modules 14-24 allow for electronic augmentation in place of the mechanical fixes to augment stability, either through smart servo technology or via hybrid fly-by-wire (FBW) surfaces.

The stick force per NZ schedule module 14 may be communicably coupled to receive from the aircraft sensors 12 airspeed (e.g., Qbar) and vertical acceleration (e.g., NZ) and may be configured to increase a nose down torque command with increasing vertical acceleration. Furthermore, the stick force per NZ schedule module 14 may be configured to normalize its output command based on the airspeed of the aircraft. The amounts of compensation may be calculated mathematically and/or determined using an NZ or vertical acceleration compensation torque schedule table.

The stick force per airspeed schedule module 16 may be communicably coupled to receive from the aircraft sensors 12 airspeed (e.g., Qbar) and knots calibrated airspeed (e.g., KCAS) and may be configured to adjust the nose down torque command based on airspeed and knots calibrated airspeed to achieve sufficient nose down torque and adjust the aircraft speed stability. The amounts of compensation may be calculated mathematically and/or determined using a stick force per airspeed schedule table.

The flap pitch bias schedule module 18 may be communicably coupled to receive from the aircraft sensors 12 altitude, knots calibrated airspeed (e.g., KCAS), and flap position. Using these inputs, the flap pitch bias schedule module 18 may output a torque command based on flap position and direction along with altitude and knots calibrated airspeed to minimize the aircraft pitch response due to flap transitions.

The AOA soft protection schedule module 20 may be communicably coupled to receive from the aircraft sensors 12 airspeed (e.g., Qbar), angle of attack (AOA), and flap position. As AOA increases to a critical angle (which may be different for different flap settings), the AOA soft protection schedule module 20 may be configured to output a nose down torque command that will work against the pilot force (via the servo motor applying directional force to the aircraft control inceptor) to increase the total pilot force required to stall the aircraft.

The pitch damper logic module 22 may be communicably coupled to receive from the aircraft sensors 12 airspeed (e.g., Qbar), vertical acceleration (e.g., NZ), aircraft pitch angle (e.g., theta), and pitch rate as input. The pitch damper logic module 22 is configured to use the airspeed, vertical acceleration, aircraft pitch angle, and pitch rate, via a damping function, to output an appropriate torque command to the servo motor or the servo control and dynamics system 25.

The stick force per CG normalization module 24 may be communicably coupled to receive from the aircraft sensors 12 airspeed (e.g., Qbar and/or KCAS), pitch trim position, and weight estimator data. The stick force per CG normalization module 24 can, as the aircraft center of gravity moves, increase the responsive torque output command as a function of servo position to normalizes the stick forces or aircraft control inceptor forces. Note that references to the stick or stick forces, as described herein, refer to pilot controls such as the aircraft control inceptor and/or the forces applied thereto by the servo control and dynamics system 25 described herein.

The Mach trim module 23 may be communicably coupled to receive from the aircraft sensors 12 Mach numbers and stabilizer position. The Mach trim module 23 can operate to offset the elevator position versus stabilizer position at higher Mach numbers (e.g., above a pre-defined Mach threshold) to prevent Mach tuck. Specifically, output from the Mach trim module 23 may be configured for applying a force via the pitch servo to help drive the elevators to a desired position.

As noted above, the gain circuitry 26 may boost or otherwise calibrate the output signal of the compensation modules 14-24 as needed for additional processing and/or increase or decrease the command authority of the values output by the compensation modules 14-24. For example, some aircrafts may need more command authority for a damping function or augmentation function than other aircrafts, so the gain circuitry 26 can be used to adjust that authority as needed to tune those commands to the aircraft. In one or more embodiments, the gain circuitry 26 may be configured as a module-command-to-torque-command conversion gain.

The signal summing and limiting module 28 can include hardware circuitry, software, or some combination thereof. The signal summing and limiting module 28 may receive the input from the compensation modules 14-24 and/or the gain circuitry 26 and calculate a desired output to send to the servo control and dynamic system 25, such as by summing the different commands together into a final servo command for the servo control and dynamics system 25 and/or servo motors thereof. Furthermore, the signal summing and limiting module 28 also includes a limiting portion thereof which limits what signal can be output to the servo control and dynamics system 25.

The servo control and dynamics system 25 controls or actuates various elements of the aircraft plant 30 (e.g., a stick, such as a lever by which a pilot controls the ailerons and elevator of an aircraft). For example, the servo control and dynamics system 25 includes at least one servo motor or actuator physically couplable to an aircraft control inceptor (e.g., an aircraft control lever, stick, or the like) and configured to provide reactive forces that work against the pilot or assists the pilot as the pilot manually manipulates the aircraft control inceptor. The servo control and dynamics system 25 can include electric motor servos with one or more controllers. For example, the one or more electric motor servos or servo motors can include a an electromechanical actuator, an autopilot servo, an electro-hydraulic actuator, or the like. However additional servos may be physically coupled with the stick or lever described herein as well without departing from the scope of the invention.

Additionally or alternatively, some embodiments of the servo control and dynamics system 25 may include a servo kit, a PID gain (e.g., Proportional, Integral, and Derivative control loop for servo tuning), a saturation component, and a torque servo operable to provide actuation of various aircraft plant components and to provide torque and/or current feedback to the servo kit. The servo kit and the PID gain may provide a forward gain or other necessary gains for the servo motors (e.g., the torque servo) of the servo control and dynamics system 25. The saturation component may be used to control saturation limits that are output to command the servo motor or torque servo. The servo motors or torque servos themselves may operate to adjust the aircraft control inceptor or stick described herein and then the output loop from the servo motors or torque servos may also provide a closed loop command for any required adjustments for the servo control and dynamics system 25 based on manual adjustment of the aircraft control inceptor by the pilot or operator thereof. The aircraft control inceptor then controls the aircraft response. Additionally or alternatively, the servo motor or servo motors could be configured to actuate other user controls besides the aircraft control inceptor that likewise impacts the aircraft’s physical response, such that the compensation modules 14-24 adjust the response provided when those aircraft controls are manually operated.

The servo control and dynamics system 25 may also include one or more components of the aircraft’s autopilot system. In some embodiments, the servo control and dynamics system 25 comprises one or more software modules and/or hardware components of an autopilot servo system. For example, the software modules and/or hardware components of the autopilot servo system can comprise a control system including a processing element, memory elements, and/or communication elements as described below for executing various autopilot commands and/or executing instructions from the signal summing and limiting module and/or the compensation modules described herein.

In some alternative embodiments, note that servo control and dynamics system 25 described herein may be replaced with any servo control system, including any smart servo and/or controllers for fly-by-wire (FBW) surfaces. For example, the output from the compensation modules 14-24 (and/or the gain circuitry 26 or the summing and limiting module 28) may include a torque command to a smart servo or position and/or rate commands to FBW surfaces.

In use, the servo control and dynamics system 25 may physically actuate and/or provide augmented control force to various elements of the aircraft plant 30 (e.g., the aircraft control inceptor) based on output from the compensation modules 14-24. The response of the aircraft plant 30 or any components of the aircraft can be in turn sensed by the aircraft sensors 12, creating a feedback loop for continual adjustments via the compensation modules 14-24 as needed. The compensation modules 14-24 described above may be configured for receiving input from the sensors 12 and instructing the servo motor(s) regarding a direction and/or an amount of the reactive forces that the servo motor(s) provide to the aircraft control inceptor based upon the input from the sensors 12.

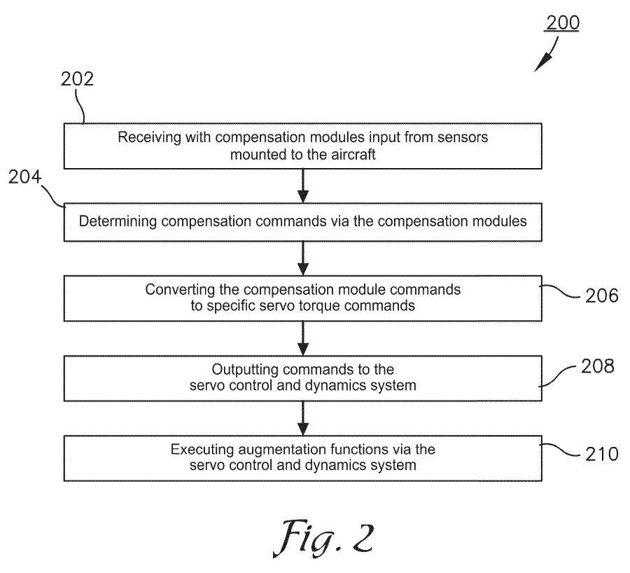

The flow chart of FIG. 2 depicts the steps of an exemplary method 200 for providing pitch stability for an aircraft during manual flight by a pilot in more detail. In some embodiments, various steps may be omitted, or steps may occur out of the order depicted in FIG. 2 without departing from the scope of the technology as described herein. For example, two blocks shown in succession in FIG. 2 may in fact be executed substantially concurrently, or blocks may sometimes be executed in the reverse order depending upon the functionality involved.

For example, the method 200 includes a step of receiving with one or more compensation modules 14-24 input from sensors 12 mounted to the aircraft, as depicted in block 202. As discussed above, the sensors 12 are configured for sensing one or more conditions experienced by the aircraft in real time, such as airspeed, roll rate, or any of the other aircraft variables relevant to flight control dynamics.

The method 200 further comprises determining compensation commands via the one or more compensation modules 14-24, as depicted in block 204. Specifically, the compensation commands include instructions, based upon the input from the sensors 12, for at least one of the servo motors regarding a direction and/or an amount of the reactive force to provide to the aircraft control inceptor or other aircraft plant components controllable by the pilot. The compensation modules 14-24 may include algorithms, functions, tables, schedules, or other instructive computer code that will provide output based on the input received from the sensors.

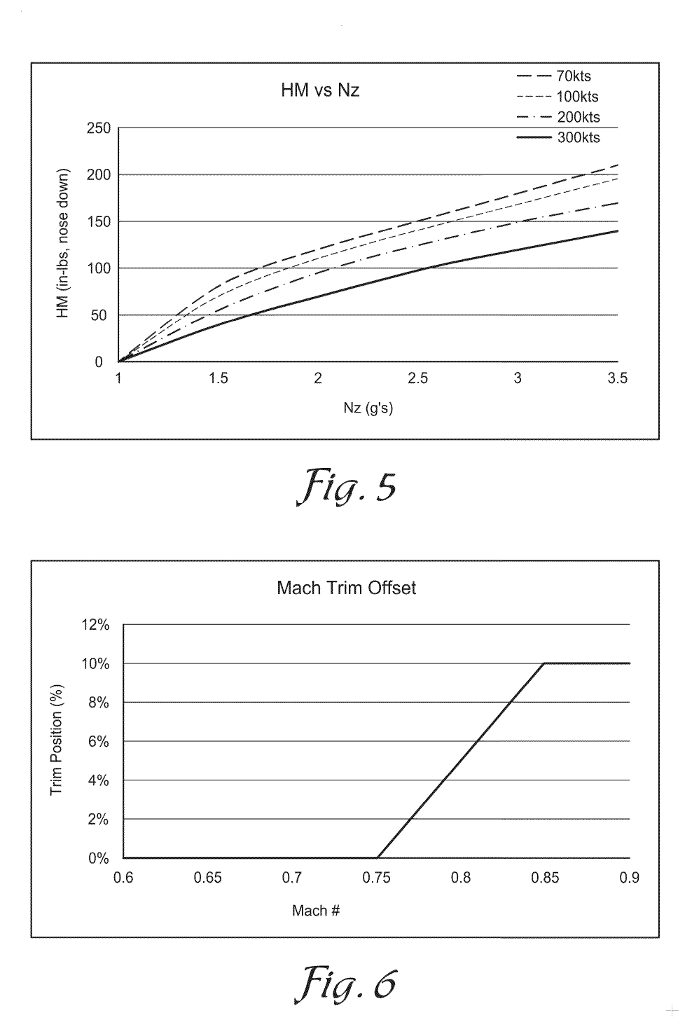

For example, in some embodiments, the step described in block 204 can be performed with the stick force per NZ schedule module 14, receiving airspeed and vertical acceleration from the sensors and outputting commands to increase a nose down torque command output to the servo motor or servo motors when increasing vertical acceleration is sensed by the sensors. Furthermore, the step in block 204 may include normalizing the nose down torque command output based on the airspeed of the aircraft, which may, for example, also be preformed via the stick force per NZ schedule module 14. One example of a function that may be utilized by the stick force per NZ schedule module 14 is depicted in FIG. 5. In FIG. 5, note that “HM” labeled thereon stands for “hinge moment” of the aerodynamic surfaces.

Furthermore, in some embodiments, the step described in block 204 can be performed with the stick force per airspeed schedule module 16, receiving from the aircraft sensors 12 airspeed (e.g., Qbar) and knots calibrated airspeed (e.g., KCAS) and adjusting the nose down torque command based on the airspeed and knots calibrated airspeed to achieve sufficient nose down torque and adjust the aircraft speed stability. The amount of compensation may be calculated mathematically and/or determined using the stick force per airspeed schedule table. One example of a function that may be utilized by the stick force per airspeed schedule module 16 is depicted in FIG. 4.

Additionally, in some embodiments, the step described in block 204 is performed with the flap pitch bias schedule module 18, receiving from the aircraft sensors 12 altitude, knots calibrated airspeed (e.g., KCAS), and flap position and outputting a torque command based on flap position and direction, along with altitude and knots calibrated airspeed, to minimize the aircraft pitch response due to flap transitions.

In some embodiments, the step described in block 204 is performed with the AOA soft protection schedule module 20, receiving from the aircraft sensors 12 airspeed (e.g., Qbar), angle of attack (AOA), and flap position. For example, as AOA increases to a critical angle (which may be different for different flap settings), the AOA soft protection schedule module 20 outputs a nose down torque command that will work against the pilot force (via the servo motor applying directional force to the aircraft control inceptor) to increase the total pilot force required to stall the aircraft.

In some embodiments, the step described in block 204 is performed with the pitch damper logic module 22, receiving from the aircraft sensors 12 airspeed (e.g., Qbar), vertical acceleration (e.g., NZ), aircraft pitch angle (e.g., theta), and pitch rate as input and, via a damping function, outputting a compensating torque command to the servo motor or the servo control and dynamics system 25. .

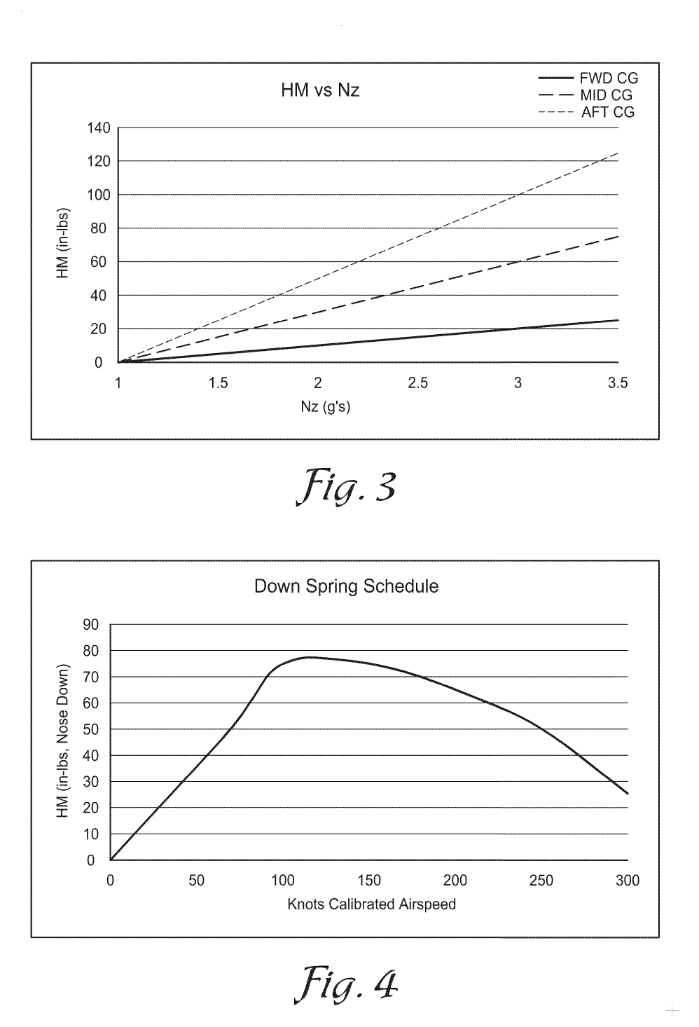

Additionally, in some embodiments, the step described in block 204 is performed with the stick force per CG normalization module 24, receiving from the aircraft sensors 12 airspeed (e.g., Qbar and/or KCAS), pitch trim position, and weight estimator data and, as the aircraft center of gravity moves, increasing the responsive torque output command as a function of service and servo position to normalize the stick forces or aircraft control inceptor forces. An example of functions that may be used for the stick force per CG normalization module 24 is depicted in FIG. 3. In FIG. 3, note that “HM” labeled thereon stands for “hinge moment” of the aerodynamic surfaces and is provided as a function of NZ or vertical acceleration.

In one or more embodiments, the step described in block 204 is additionally or alternatively performed with the Mach trim module 23, receiving from the aircraft sensors 12 a Mach number and stabilizer position and as the Mach numbers increase above a desired amount or threshold, the Mach trim module 23 operates to offset the elevator position versus stabilizer position at those higher Mach numbers to prevent Mach tuck. Specifically, output from the Mach trim module 23 may apply a force via the pitch servo to help drive the elevators to a desired corrected position. An example embodiment of Mach trim offset is depicted in FIG. 6, where a percent trim position is increased as a function of the Mach number.

In some embodiments, the method includes a step of converting the compensation module commands to specific servo torque commands, as depicted in block 206. In some embodiments, this may include summing and/or weighting the compensation commands from a plurality of the compensation modules and converting these summed and weighted commands into a pitch stability compensation command. In some embodiments, gain or boost may also be provided to one or more of the compensation module commands received from the compensation module. As described above, in some embodiments the gain circuitry 26 may receive control module output and convert it to a torque command. However, in one or more embodiments, the method step 206 may be omitted without departing from the scope of the technology described herein.

In one or more example embodiments, the step 206 may be performed with the summing and limiting module 28 and/or the gain circuitry 26. The summing may be performed in a weighted manner in accordance with flight control requirements. Furthermore, in some embodiments, the compensation commands can be weighted, summed, and/or limited by the gain circuitry 26 and/or the summing and limiting module 28 in accordance with control needs of a particular aircraft to determine the pitch stability compensation command. The pitch stability compensation command provided to the servo control and dynamics system 25 as described below may be any one or more of the compensation commands described herein, with or without additional processing such as described in block 206. For example, in some embodiments, the gain circuitry 26 and/or the summing and limiting module 28 can be omitted or replaced with other relevant processing circuitry without departing from the scope of the invention. Specifically, in some alternative embodiments, one of the compensation commands may be fed directly to the servo control and dynamics system 25. Conversely, in some embodiments, the compensation commands may be processed by the gain circuitry 26 and/or the summing and limiting module 28 or other processing circuitry before being fed into the servo control and dynamics system 25 without departing from the scope of the invention.

The method 200 also comprises a step of outputting commands to the servo control and dynamics system 25, as depicted in block 208. The commands may be the servo torque commands output in step 206 above and/or may be output from any one or more of the compensation commands from the compensation modules 14-24 described above. Specifically, in some embodiments, the commands may be the pitch stability compensation command, determined based on one or more of the compensation commands from the compensation modules 14-24 after those compensation commands are processed, filtered, weighted, combined, or the like (e.g., processed via the summing and limiting module 28 and/or the gain circuitry 26). As noted above, the servo control and dynamics system 25 includes at least one servo motor (e.g., a pitch servo, fly-by-wire pitch control surfaces, or the like). Those servo motors are physically coupled to the aircraft control inceptor and provide reactive forces that work against the pilot or assist the pilot as the pilot manually manipulates the aircraft control inceptor, for example. While the embodiments above describe the servo control and dynamics system 25 receiving torque commands for a smart servo, additionally or alternatively, control signals output from the compensation modules 14-24, and/or weighted by the summing and limiting module 28, may provide position and/or rate commands to fly-by-wire (FBW) surfaces.

In some embodiments, the method 200 further comprises executing augmentation functions via the servo control and dynamics system 25, as depicted in block 210. For example, the augmentation functions may include one or more of pitch, roll, yaw, and throttle via the servo control and dynamics system 25. In some example embodiments, the compensation modules 14-24 to may utilize autopilot systems to perform the augmentation functions and meet handling requirements / provide the necessary control feedback to the pilot (e.g., via servo force applied to the aircraft control inceptor) during flight instead of mechanical fixes such as springs, interconnects, surface modifications or centering strips used in prior art aircrafts in order to pass all handling qualities requirements in the pitch control axes.

Note that the compensation modules described herein are primarily directed toward pitch stability and producing pitch stability compensation commands. However, other compensation modules may output other types of compensation commands without departing from the scope of the invention. For example, U.S. Patent Application No. ________, entitled SYSTEM AND METHOD FOR ELECTRONIC LATERAL-DIRECTIONAL STABILITY AUGMENTATION, also filed on ______ and incorporated by reference herein in its entirety, describes compensation modules directed toward lateral and directional stability. Thus, compensation modules for lateral and directional stability may be used along with the compensation modules for pitch stability described herein without departing from the scope of the invention. Please also note that for FIGS. 3-6, any of the curves depicted therein may be modified as needed to meet desired handling qualities of any specific aircraft without departing from the scope of the technology as described herein.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A pilot assist system for providing electronic pitch stability for an aircraft, the system comprising:
sensors mountable to the aircraft and configured for sensing one or more conditions experienced by the aircraft in real time;
at least one servo motor configured to provide reactive forces that work against the pilot or assists the pilot as the pilot manually manipulates an aircraft control inceptor; and
one or more compensation modules configured for receiving input from the sensors and instructing the at least one servo motor regarding a direction and an amount of the reactive forces that the at least one servo motor provides to the aircraft control inceptor based upon the input from the sensors.

2. The system of claim 1, further comprising a servo control and dynamics system including the at least one servo motor, wherein the servo control and dynamics system is further configured to execute augmentation functions including one or more of pitch, roll, yaw, and throttle.

3. The system of claim 1, wherein the one or more compensation modules includes an stick force per NZ schedule module communicably coupled to receive from the sensors airspeed and vertical acceleration, wherein the stick force per NZ schedule module is configured to increase a nose down torque command output to the at least one servo motor when increasing vertical acceleration is sensed by the sensors.

4. The system of claim 3, wherein the stick force per NZ schedule module is further configured to normalize the nose down torque command output based on the airspeed of the aircraft.

5. The system of claim 1, wherein the one or more compensation modules includes a stick force per airspeed schedule module configured to receive airspeed and knots calibrated airspeed from the sensors and configured to output commands to adjust a nose down torque command provided to the at least one servo motor based on the airspeed and knots calibrated airspeed to achieve sufficient nose down torque and adjust speed stability of the aircraft.

6. The system of claim 1, wherein the one or more compensation modules include a flap pitch bias schedule module configured to receive altitude, knots calibrated airspeed, and flap position from the sensors and configured to output a torque command to the at least one servo motor based on flap position and direction, along with altitude and knots calibrated airspeed, to minimize the aircraft pitch response due to flap transitions.

7. The system of claim 1, wherein the one or more compensation modules include an angle of attack (AOA) soft protection schedule module configured to receive airspeed, AOA, and flap position from the sensors and configured to output a nose down torque command to the at least one servo motor when the AOA increases to a critical angle, thus increasing a total pilot force required to stall the aircraft.

8. The system of claim 1, wherein the one or more compensation modules include a pitch damper logic module configured to receive airspeed, vertical acceleration, aircraft pitch angle, and pitch rate from the sensors and, using a damping function, output a compensating torque command to the at least one servo motor.

9. The system of claim 1, wherein the one or more compensation modules include with a stick force per center of gravity (CG) normalization module configured to receive airspeed, pitch trim position, and weight estimator data from the sensor sand, as a center of gravity of the aircraft moves, increase a responsive torque output command provided to the at least one servo motor as a function of service and servo position to normalize aircraft control inceptor forces.

10. The system of claim 1, wherein the one or more compensation modules are configured to instruct the at least one servo motor to react according to at least one of the following:
a. vertical acceleration augmentation based on aircraft control inceptor force,b. airspeed augmentation based on aircraft control inceptor force,c. aircraft center of gravity (CG) normalization based on aircraft control inceptor force,d. flap extension and retraction force bias,e. pitch damping, f. soft angle of attack (AOA) limit protection, andg. Mach trim offsetting an elevator position versus stabilizer position at high Mach numbers to prevent Mach tuck.

11. A method for providing electronic pitch stability for an aircraft, the method comprising:
receiving with compensation modules input from sensors mounted to the aircraft, wherein the sensors are configured for sensing one or more conditions experienced by the aircraft in real time;
determining compensation commands via the compensation modules, wherein the compensation commands include instructions for at least one servo motor based upon the input from the sensors; and
outputting the compensation commands to a servo control and dynamics system including the at least one servo motor, wherein the at least one servo motor is physically coupled to an aircraft control inceptor and is configured to, based on the compensation commands, provide reactive forces that work against the pilot or assists the pilot as the pilot manually manipulates the aircraft control inceptor.

12. The method of claim 11, further comprising executing augmentation functions including one or more of pitch, roll, yaw, and throttle via the servo control and dynamics system.

13. The method of claim 11, further comprising receiving with at least one of the compensation modules airspeed and vertical acceleration from the sensors and outputting commands to increase a nose down torque command output to the at least one servo motor when increasing vertical acceleration is sensed by the sensors and to normalize the nose down torque command output based on the airspeed of the aircraft.

14. The method of claim 13, further comprising normalizing the nose down torque command output based on the airspeed of the aircraft.

15. The method of claim 11, further comprising receiving airspeed and knots calibrated airspeed from the sensors and outputting commands to adjust a nose down torque command provided to the at least one servo motor based on the airspeed and the knots calibrated airspeed to achieve sufficient nose down torque and adjust speed stability of the aircraft.

16. The method of claim 11, further comprising receiving altitude, knots calibrated airspeed, and flap position from the sensors and outputting a torque command to the at least one servo motor based on flap position and direction, along with altitude and knots calibrated airspeed, to minimize the aircraft pitch response due to flap transitions.

17. The method of claim 11, further comprising receiving airspeed, angle of attack (AOA), and flap position from the sensors and outputting a nose down torque command to the at least one servo motor when the AOA increases to a critical angle, thus increasing a total pilot force required to stall the aircraft.

18. The method of claim 11, further comprising receiving airspeed, vertical acceleration, aircraft pitch angle, and pitch rate from the sensors and, using a damping function, outputting a compensating torque command to the at least one servo motor.

19. The method of claim 11, further comprising receiving airspeed, pitch trim position, and weight estimator data from the sensors and, as a center of gravity of the aircraft moves, increasing a responsive torque output command provided to the at least one servo motor as a function of service and servo position to normalize aircraft control inceptor forces.

20. A method for providing electronic pitch stability for an aircraft, the method comprising:
receiving with compensation modules input from sensors mounted to the aircraft, wherein the sensors are configured for sensing one or more conditions experienced by the aircraft in real time;
determining compensation commands via the compensation modules based on input from the sensors, wherein the compensation modules are configured to determine the compensation commands according to at least one of the following functions of the compensation modules:
a. vertical acceleration augmentation based on aircraft control inceptor force,b. airspeed augmentation based on aircraft control inceptor force,c. aircraft center of gravity (CG) normalization based on aircraft control inceptor force,d. flap extension and retraction force bias,e. pitch damping, f. soft angle of attack (AOA) limit protection, andg. Mach trim offsetting of an elevator position versus stabilizer position at high Mach numbers to prevent Mach tuck;
summing the compensation commands from a plurality of the compensation modules into a pitch stability compensation command, wherein the summing is performed in a weighted manner in accordance with flight control requirements; and
outputting the pitch stability compensation command to a servo control and dynamics system including at least one servo motor, wherein the at least one servo motor is physically coupled to an aircraft control inceptor and configured to provide reactive forces that work against the pilot or assists the pilot as the pilot manually manipulates the aircraft control inceptor.
